(19) United States
(12) Patent Application Publication
(10) Pub. No.: US 2023/0259674 A1
(43) Pub. Date: Aug. 17, 2023

(54) ENERGY FUNCTION DERIVATION DEVICE, METHOD, AND COMPUTER-READABLE RECORDING MEDIUM

(71) Applicant: NEC Corporation, Minato-ku, Tokyo (JP)

(72) Inventors: Fumiyo Takano, Tokyo (JP); Hiroaki Inoue, Tokyo (JP); Takuya Araki, Tokyo (JP); Motoi Suzuki, Tokyo (JP); Yuki Kobayashi, Tokyo (JP); Takahiro Nishimura, Tokyo (JP); Hiroshi Chishima, Tokyo (JP); Akihiro Yatabe, Tokyo (JP)

(73) Assignee: NEC Corporation, Minato-ku, Tokyo (JP)

(21) Appl. No.: 18/014,308

(22) PCT Filed: Jul. 6, 2020
(86) PCT No.: PCT/JP2020/026349

§ 371 Date: Jan. 3, 2023

(51) Int. Cl. G06F 30/20; G06F 17/18

(52) U.S. Cl. CPC G06F 30/20; G06F 17/18; G06F 2111/06

(57) ABSTRACT

The term generation means 73 generates a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change. The energy function derivation means 74 deriving a new energy function by adding terms generated by the term generation means 73 for each pair to the energy function.

### TECHNICAL FIELD

This invention relates to an energy function derivation device, an energy function derivation method, and a computer-readable recording medium in which an energy function derivation program is recorded, that derive an energy function of a model representing states of individual spins by a first value or a second value.

### BACKGROUND ART

A solution to a combinatorial optimization problem can be obtained by applying an energy function of the Ising model or an energy function of QUBO (Quadratic Unconstrained Binary Optimization), for example, simulated annealing.

The Ising model is a model in statistical mechanics that represents the behavior of a magnetic material by individual spins, and it is also applicable to solving combinatorial optimization problems. In the Ising model, the states of individual spins are represented by “1” or “−1”.

QUBO is also known as a model in which the states of individual spins are represented by “1” or “0”.

Note that “1” in the Ising model and “1” in QUBO can be referred to as the first value, and, “−1” in the Ising model and “0” in QUBO can be referred to as the second value.

The energy function of the Ising model and the energy function of QUBO are mutually convertible.

In the current situation, the solution of the combinatorial optimization problem is obtained by simulated annealing using a general computer mainly with the energy function of the Ising model or in QUBO as input. An example of this method is described below.

First, an expression that represents the energy in the combinatorial optimization problem is generated. The generation of the expression representing energy in the combinatorial optimization problem may be referred to as formulation.

Once the expression representing energy in the combinatorial optimization problem has been generated, the expression is converted to the energy function of the Ising model or the energy function of QUBO. This conversion method is known.

The energy function of the Ising model is expressed as the following Expression (1).

### [Math. 1]

H_{Ising}=ΣᵢⱼJᵢⱼxᵢxⱼ+Σᵢhᵢxᵢ (1)

In Expression (1), xᵢ, xⱼ are variables that represent a state of a spin. The subscripts in these variables identify the spins. Jᵢⱼ is a constant related to i and j, and hᵢ is a constant related to i.

The energy function of QUBO is expressed as the following Expression (2).

### [Math. 2]

H_{QUBO}=ΣᵢⱼQᵢⱼxᵢxⱼ (2)

In Expression (2), xᵢ, xⱼ are variables that represent a state of a spin. The subscripts in these variables identify the spins. Qᵢⱼ is a constant related to i and j.

Once the energy function of the Ising model or the energy function of QUBO is obtained, the energy function is applied to simulated annealing to specify the state of each spin when the energy is minimized. The state of each spin is then interpreted as the solution to the combinatorial optimization problem.

Note that PTL 1 describes searching for the ground state of the Ising model using the initial operating conditions.

### CITATION LIST

### Patent Literature

PTL 1: Japanese Patent Application Laid-Open No. 2019-160169

### SUMMARY OF INVENTION

### Technical Problem

Hereafter, a person who tries to obtain a solution to a combinatorial optimization problem is referred to as a user.

It is assumed that a solution to a certain combinatorial optimization problem has been obtained. However, a user may wish to change at least part of the solution in response to some change in circumstances. In the following, such a situation is explained. In the following explanation, the work shift creation problem will be used as an example of a combinatorial optimization problem. In this example, it is assumed that an expression representing the energy in the work shift creation problem is created that reflects the constraints of “two or more people should work each day”, “no more than three consecutive work days”, and “no more than two consecutive holidays”, and that the expression is converted into an energy function of QUBO. Moreover, it is assumed that the energy function is then applied to simulated annealing and the solution shown in FIG. 8 is obtained.

In the table shown in FIG. 8, the day of the week is shown horizontally. In the table shown in FIG. 8, A, B, and C in the vertical direction indicate the workers. In the table shown in FIG. 8, each state of the 15 spins from spin 1 to 15 is represented by “1” or “0”. In this example, “1” is assumed to mean that the worker is at work, and “0” is assumed to mean that the worker is not at work.

After the solution shown in FIG. 8 is obtained, there may be a case in which the user wishes to change the solution so that the worker C can take a holiday on Tuesday because the worker C has an urgent business on Tuesday. That is, the user may wish to change the value of spin 12 from “1” to “0”. In this case, it is conceivable that the user does not wish to change the attendance status of other workers as much as possible.

The above example is an example of a case in which the user wishes to change at least part of the solution to a combinatorial optimization problem once obtained, in response to some change in circumstances.

In order to be able to deal with the cases exemplified above, it is desirable to be able to derive an energy function that can obtain a solution to a combinatorial optimization problem with the desired modifications to already-obtained-solution, when the user wishes to change the already-obtained-solution.

Therefore, an object of the present invention is to provide an energy function derivation device, an energy function derivation method, and a computer-readable recording medium in which an energy function derivation program is recorded, that can obtain a solution to a combinatorial optimization problem with the desired modifications to already-obtained-solution, when the user wishes to change the already-obtained-solution.

### Solution to Problem

A energy function derivation device according to the present invention includes: term generation means for generating a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and energy function derivation means for deriving a new energy function by adding terms generated by the term generation means for each pair to the energy function.

A energy function derivation method according to the present invention comprises: generating a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and deriving a new energy function by adding terms generated for each pair to the energy function.

A computer-readable recording medium according to the present invention is a computer-readable recording medium in which an energy function derivation program is recorded, wherein the energy function derivation program causes a computer to execute: a term generation process of generating a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and an energy function derivation process of deriving a new energy function by adding terms generated in the term generation process for each pair to the energy function.

### Advantageous Effects of Invention

According to the present invention, it is able to derive an energy function that can obtain a solution to a combinatorial optimization problem with the desired modifications to already-obtained-solution, when the user wishes to change the already-obtained-solution.

### BRIEF DESCRIPTION OF DRAWINGS

FIG. 1 It depicts a block diagram showing an example configuration of an energy function derivation device of the example embodiment of the present invention.

FIG. 2 It depicts a schematic diagram showing the change in meaning with a change in degree of wish to change.

FIG. 3 It depicts a schematic diagram showing the method of determining kᵢ and α.

FIG. 4 It depicts a schematic diagram showing the magnitude of the value of V₃ and the value of a corresponding to the various degrees of wish to change.

FIG. 5 It depicts a flowchart showing an example of the processing flow of the example embodiment of the present invention.

FIG. 6 It depicts a schematic block diagram showing an example of computer configuration related to the energy function derivation device 1 of the example embodiment of the present invention.

FIG. 7 It depicts a block diagram showing an overview of the energy function derivation device of the present invention.

FIG. 8 It depicts a schematic diagram showing an example of a solution to a combinatorial optimization problem.

### DESCRIPTION OF EMBODIMENTS

Example embodiment of the present invention is described below with reference to the drawings.

In the following discussion, the case where the energy function of QUBO is applied to annealing (e.g., simulated annealing) to obtain a solution to a combinatorial optimization problem is used. However, the present invention is also applicable to the case where the solution to the combinatorial optimization problem is obtained by applying the energy function of the Ising model to annealing. As already mentioned, “1” in the Ising model and “1” in QUBO can be referred to as the first value. “−1” in the Ising model and “0” in QUBO can be referred to as the second value.

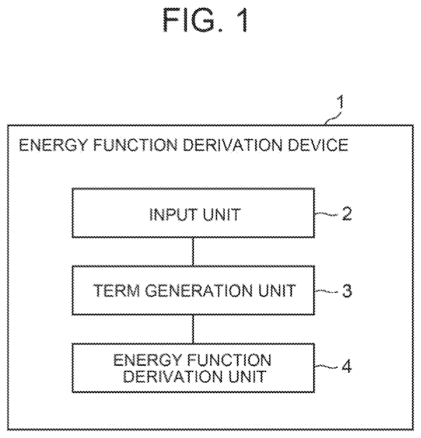

FIG. 1 is a block diagram showing an example configuration of an energy function derivation device of the example embodiment of the present invention. The energy function derivation device 1 includes an input unit 2, a term generation unit 3, and an energy function derivation unit 4.

A solution to a combinatorial optimization problem already obtained and the energy function of QUBO used in obtaining the solution are input to input unit 2. A solution to a combinatorial optimization problem already obtained and the energy function of the Ising model used in obtaining the solution may also be input to input unit 2.

Here, the solution input into the input unit 2 is the solution that the user wishes to change, at least in part.

Moreover, a pair of identification information of spin and degree of wish to change are also input to the input unit 2. The number of pairs of the identification information of spin and the degree of wish to change to be input to input unit 2 may be one or more. The pair of the identification information of spin and the degree of wish to change may be defined for all spins in the solution, and all pairs may be input to the input unit 2.

The degree of wish to change paired with the identification information of spin is a value indicating the degree to which the user wishes to change the state of spin corresponding to the identification information, in the input solution.

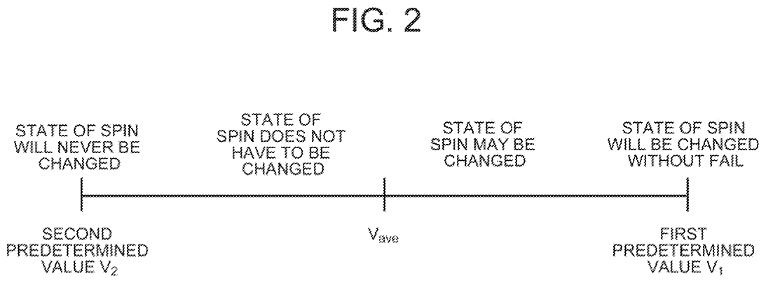

FIG. 2 is a schematic diagram showing the change in meaning with a change in degree of wish to change. The degree of wish to change is a continuous value ranging from a first predetermined value (hereafter referred to as V₁), which means that the state of spin corresponding to the identification information paired with the degree of wish to change will be changed without fail, to a second predetermined value (hereafter referred to as V₂), which means that the state of spin corresponding to the identification information paired with the degree of wish to change will never be changed. It may be V₂>V₁ or V₁>V₂. In the following, the case where V₂>V₁ is used as an example. The average of V₁ and V₂ is noted as Vₐᵥₑ.

When the degree of wish to change is V₁, it means that the state of spin corresponding to the identification information paired with the degree of wish to change will be changed without fail, as described above. As the degree of wish to change approaches V₁ to Vₐᵥₑ, the degree of wish to change comes to mean that the state of spin may be changed, and the degree to which the state of spin is to be changed decreases. When the degree of wish to change is V₂, it means that the state of spin corresponding to the identification information paired with the degree of wish to change will never be changed, as described above. As the degree of wish to change approaches V₂ to Vₐᵥₑ, the degree of wish to change comes to mean that the state of spin does not have to be changed, and the degree of unwillingness to change the spin state decreases. The degree of wish to change of Vₐᵥₑ means that the spin state may or may not be changed.

The term generation unit 3, via input unit 2, takes in the solution to the combinatorial optimization problem already obtained, the energy function of QUBO used in obtaining the solution, and, the pair of the identification information of spin and the degree of wish to change. As mentioned above, the number of pairs of the identification information of spin and the degree of wish to change may be one or more.

Then, for each pair of the identification information of spin and the degree of wish to change, the term generation unit 3 generates a term based on the state of spin corresponding to the identification information in the input solution and the degree of wish to change.

Specifically, the term generation unit 3 generates a term of the form α×(kᵢ−xᵢ)² for each pair of the identification information of spin and the degree of wish to change.

xᵢ is the identification information of spin in the pair taken in.

kᵢ is the value corresponding to, the state of spin corresponding to the identification information i in the input solution, or the inverted state of the state. In this example, kᵢ takes the value of either “1” or “0”.

x₁ is a variable that represents the state of spin corresponding to the identification information i.

α is a value according to the degree of wish to change paired with the identification information i.

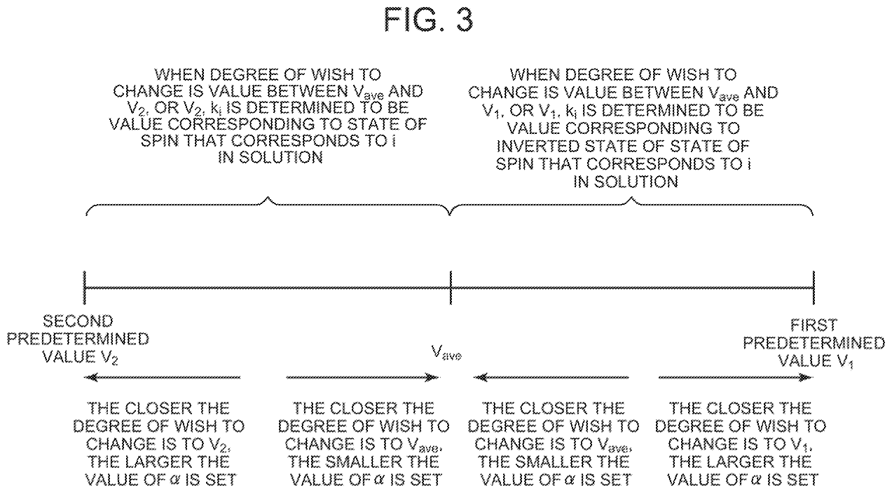

The term generation unit 3 generates a term of the form α×(kᵢ−xᵢ)² for each pair. The method of determining kᵢ and α in this case is explained below. FIG. 3 is a schematic diagram showing the method of determining kᵢ and α.

First, how kᵢ is determined is explained.

When the degree of wish to change is a value between Vₐᵥₑ and V₁, or V₁, then kᵢ is determined to be a value corresponding to the inverted state of the state of spin that corresponds to the identification information i in the input solution. For example, it is assumed that the solution shown in FIG. 8 is taken in. The identification information of spin of the pair of interest is “12”. Also, it is assumed that the degree of wish to change paired with the identification information “12” is a value between Vₐᵥₑ and V₁. In the solution exemplified in FIG. 8, the inverted state of the state of spin 12 “1” is “0”. Therefore, in this case, the term generation unit 3 sets the value of k12 to “0”. The same is true when the degree of wish to change is V₁.

When the degree of wish to change is a value between Vₐᵥₑ and V₂, or V₂, then kᵢ is determined to be the value corresponding to the state of spin that corresponds to the identification information i in the input solution. For example, it is assumed that the solution shown in FIG. 8 is taken in. The identification information of spin of the pair of interest is “2”. Also, it is assumed that the degree of wish to change paired with the identification information “2” is a value between Vₐᵥₑ and V₂. In the solution exemplified in FIG. 8, the state of spin 2 is “1”. Therefore, in this case, the term generation unit 3 sets the value of k₂ to “1”. The same is true when the degree of wish to change is V₂.

When the degree of wish to change is Vₐᵥₑ, then the term generation unit 3 may set the value of kᵢ to either “1” or “0”.

Next, how to determine α is explained. The maximum value that α can take is written as αₘₐₓ and the minimum value that α can take is written as αₘᵢₙThe case where αₘₐₓ=1 and αₘᵢₙ=0 is used, as an example.

The term generation unit 3 determines the larger the absolute value of the difference between the degree of wish to change in the pair of interest and Vₐᵥₑ, the larger the value of α in the term “α×(kᵢ−xᵢ)²” corresponding to the pair, and the term generation unit 3 determines the smaller the absolute value of the difference between the degree of wish to change in the pair of interest and Vₐᵥₑ, the smaller the value of a in the term “α×(kᵢ−xᵢ)²” corresponding to the pair.

The absolute value of the difference between the degree of wish to change and Vₐᵥₑ is largest when the degree of wish to change is V₁ or V₂. Therefore, when the degree of wish to change is V₁ or V₂, the term generation unit 3 sets the value of a to αₘₐₓ (1 in this example). The absolute value of the difference between the degree of wish to change and Vₐᵥₑ is smallest when the degree of wish to change is Vₐᵥₑ. Therefore, when the degree of wish to change is Vₐᵥₑ, the term generation unit 3 sets the value ofα to αₘᵢₙ (0 in this example). Then, the closer the degree of wish to change is to V₁ or V₂, the larger the value of a is set by the term generation unit 3. The closer the degree of wish to change is to Vₐᵥₑ, the smaller the value of a is set by the term generation unit 3.

Here is an example of a case where one pair of the identification information of spin and the degree of wish to change is input. This pair is assumed to be the pair of the identification information “12” of spin and the degree of wish to change “V₁”. It is also assumed that the solution shown in FIG. 8 is input as the solution to the combinatorial optimization problem. The fact that the pair of the identification information “12” of spin and the degree of wish to change “V₁” has been input means that the user wishes to change the state “1” of spin 12 shown in FIGS. 8 to “0” without fail. The term generation unit 3 generates the term αₘₐₓ×(0−x₁₂)² with respect to this pair. In this case, when the energy function generated as described below is applied to simulated annealing and the solution is obtained again, the state of spin 12 will be “0”, but it cannot determined whether the states of the other spins will be “1” or “0”.

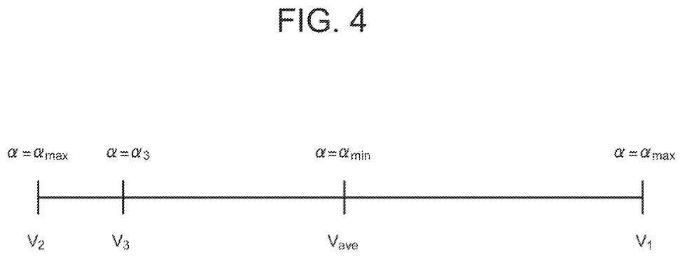

It is conceivable that the user does not wish to change the state of spin other than spin 12 as much as possible. In this case, it is sufficient to define a pair of the identification information of spin and the degree of wish to change for each spin, and input each pair into the input unit 2. Here, for spin 12, the pair of the identification information “12” and the degree of wish to change “V₁” is defined. It is assumed that the identification information is represented as “i” as to spin other than spin 12. For each pair other than spin 12, a pair of the identification information “i” and the degree of wish to change “V₃” may be defined. Here, V₃ is slightly smaller than V₂. FIG. 4 is a schematic diagram showing the magnitude of the value of V₃ and the value of a corresponding to the various degrees of wish to change. It is assumed that the value of a corresponding to the degree of wish to change “V₃” is α₃ (see FIG. 4). Here, αₘₐₓ>α₃.

In this case, the term generation unit 3 generates the term αₘₐₓ××(0−x₁₂)² for spin 12, as described above. Also, for each spin other than spin 12, the term generation unit 3 generates the term α₃×(kᵢ−xᵢ)². The value kᵢ in this term is a value representing the state of spin i in the solution shown in FIG. 8.

Specifically, the term generation unit 3 generates each of the following terms (see FIG. 8). However, in the following, some of the terms are omitted.

α₃×(0−x₁)²,

α₃×(1−x₂)²,

α₃×(1−x₃)²,

α₃×(1−x₄)²,

α₃×(1−x₅)²,

α₃×(1−x₁₁)²,

αₘₐₓ×(0−x₁₂)²,

α₃×(0−x₁₃)²,

α₃×(1−x₁₄)²,

α₃×(1−x₁₅)²,

V₃ is slightly smaller than V₂ and αₘₐₓ>α₃. Thus, when the energy function generated as described below is applied to simulated annealing and the solution is obtained again, the state of each spin other than spin 12 may have changed from the state shown in FIG. 8, but not be significantly changed.

In the following explanation, the case where the term generation unit 3 generates the multiple terms described above as an example is used.

The energy function derivation unit 4 generates a new energy function by adding the terms generated by the term generation unit 3 for each input pair to the input energy function of QUBO (i.e., the energy function of QUBO used in obtaining the input solution).

For example, it is assumed that the term generation unit 3 takes in the energy function of QUBO shown in Expression (2) via the input unit 2. It is also assumed that the term generation unit 3 has generated the above multiple terms by taking in the solution shown in FIG. 8 and the pairs corresponding to the individual spins (pairs of the identification information and the degree of wish to change). In this case, the energy function derivation unit 4 derives a new energy function by adding the above multiple terms to the right-hand side of Expression (2). This new energy function is expressed as in Expression (3) below.

### [Math. 3]

H_{QUBO}=ΣᵢⱼQᵢⱼxᵢxⱼ

+α₃×(0−x₁)

+α₃×(1−x₂)

+α₃×(1−x₃)

+α₃×(1−x₄)

+α₃×(1−x₅)

+α₃×(1−x₁₁)

+αₘₐₓ×(0−x₁₂)

+α₃×(0−x₁₃)

+α₃×(1−x₁₄)

+α₃×(1−x₁₅) (3)

When the input energy function is the energy function of the Ising model, the energy function derivation unit 4 can also generate a new energy function by adding the term generated by the term generation unit 3 to the input energy function. In this case, each state of spin is represented by “1” or “−1” in the input solution. Then, the term generation unit 3 sets the value of kᵢ in the term of the form α×(kᵢ−xᵢ)² to “1” or “−1”. Other points are the same as those already described.

The input unit 2 may be realized by a data reading device that reads data (in the present example embodiment, the solution to the combinatorial optimization problem, the energy function used in obtaining that solution, and the pair of the identification information of spin and the degree of wish to change) recorded on a data recording medium such as an optical disk, for example. However, the input unit 2 is not limited to such a data reading device, but may be a keyboard or other input device for the user to input such data.

The term generation unit 3 and the energy function derivation unit 4 are realized, for example, by a CPU (Central Processing Unit) of a computer operating according to an energy function derivation program. In this case, the CPU may read the energy function derivation program from a program storage medium such as a program storage device of the computer, and operate as the term generation unit 3 and the energy function derivation unit 4 according to the energy function derivation program.

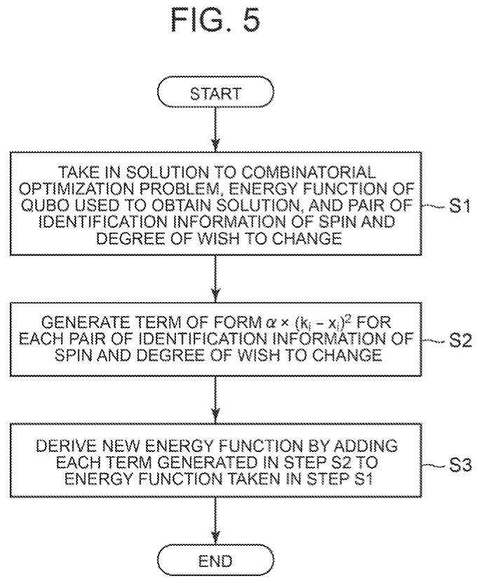

Next, the processing flow is described. FIG. 5 is a flowchart showing an example of the processing flow of the example embodiment of the present invention. Matters that have already been explained are omitted as appropriate.

The term generation unit 3 takes in the solution to the combinatorial optimization problem, the energy function of QUBO used to obtain the solution, and the pair of the identification information of spin and the degree of wish to change, via input unit 2 (step S1). The number of pairs of the identification information of spin and the degree of wish to change may be one or more.

Next, the term generation unit 3 generates a term of the form α×(kᵢ−xᵢ)² for each pair of the identification information of spin and the degree of wish to change (step S2). The methods for determining kᵢ and a have already been described, so they are omitted here.

Next, the energy function derivation unit 4 derives the new energy function by adding each term generated in step S2 to the energy function taken in step S1. (step S3). In step S3, for example, the energy function as exemplified in Expression (3) is derived.

The energy function derived in step S3 can be converted to an energy function of the form shown in Expression (2). For example, the energy function shown in Expression (3) can be converted to the energy function of QUBO shown in Expression (4) below.

[Math. 4]

H_{QUBO}=ΣᵢⱼRᵢⱼxᵢxⱼ (4)

When using the energy function of the Ising model, the newly derived energy function can also be converted to an energy function of the form shown in Expression (1). The form shown in Expression (2) and the form shown in Expression (1) are the form of the energy function when applied to annealing (e.g., simulated annealing).

The energy function derivation device 1 may include a conversion unit (not shown) that converts the energy function derived in step S3 to an energy function in the form used when applied to annealing, as described above. The conversion unit is also realized, for example, by the CPU of the computer operating according to the energy function derivation program.

The energy function applied to the form used when applied to annealing is input to a solver that performs the annealing. The solver then performs annealing using the energy function and calculates a new solution. This solution has been modified as wished by the user.

The solver may include a conversion unit (not shown) that converts the energy function derived in step S3 to an energy function in the form used when applied to annealing. In this case, the energy function derived in step S3 may be input directly to the solver. Then, the conversion unit in the solver converts the input energy function to an energy function in the form used when applied to annealing, and the solver may perform annealing using the converted energy function.

In the present example embodiment, the term generation unit 3 generates a term of the form α×(kᵢ−xᵢ)² for each pair of the identification information of spin and the degree of wish to change. This term is generated according to the degree of wish to change to the state of spin identified by the identification information. The energy function derivation unit 4 then derives a new energy function by adding each term generated by the term generation unit 3 to the input energy function. Therefore, the new energy function reflects the degree of wish to change. Therefore, the new solution obtained by annealing based on the new energy function has the desired modification. Therefore, in the present example embodiment, it is able to derive an energy function that can obtain a solution to a combinatorial optimization problem with the desired modifications to already-obtained-solution, when the user wishes to change the already-obtained-solution.

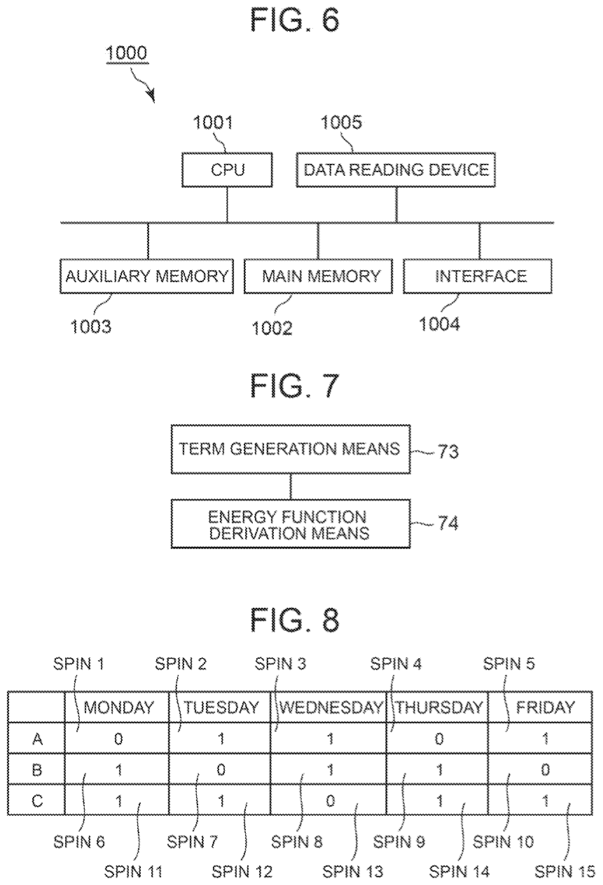

FIG. 6 is a schematic block diagram showing an example of computer configuration related to the energy function derivation device 1 of the example embodiment of the present invention. The computer 1000 includes a CPU 1001, a main memory 1002, an auxiliary memory 1003, an interface 1004, and a data reading device 1005.

The energy function derivation device 1 of the example embodiment of the present invention is realized by a computer 1000. The operation of the energy function derivation device 1 is stored in the auxiliary memory 1003 in the form of an energy function derivation program. The CPU 1001 reads the energy function derivation program from the auxiliary memory 1003, expands the energy function derivation program in the main memory 1002, and executes the process described in the above example embodiment according to the energy function derivation program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components is realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

Next, an overview of the present invention is described. FIG. 7 is a block diagram showing an overview of the energy function derivation device of the present invention. The energy function derivation device of the present invention includes term generation means 73 and energy function derivation means 74.

The term generation means 73 (e.g., the term generation unit 3) generates a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change.

The energy function derivation means 74 (e.g., the energy function derivation unit 4) deriving a new energy function by adding terms generated by the term generation means 73 for each pair to the energy function.

According to such a configuration, it is able to derive an energy function that can obtain a solution to a combinatorial optimization problem with the desired modifications to already-obtained-solution, when the user wishes to change the already-obtained-solution.

When given identification information is denoted as i, a value corresponding to the state of spin corresponding to the identification information in the solution or an inverted state of the state is denoted as kᵢ, a variable representing the state of spin corresponding to the identification information is denoted as xᵢ, and a value according to the degree of wish to change paired with the identification information is denoted as α, the term generation means 73 may generate the term of form α×(kᵢ−xᵢ)² for each pair of the identification information and the degree of wish to change.

Wherein the degree of wish to change is a continuous value ranging from a first predetermined value which means that the state of spin corresponding to the identification information paired with the degree of wish to change will be changed without fail, to a second predetermined value which means that the state of spin corresponding to the identification information paired with the degree of wish to change will never be changed, an average of the first predetermined value and the second predetermined value is denoted as Vₐᵥₑ, when the degree of wish to change paired with given identification information i of spin is a value between Vₐᵥₑ and the first predetermined value, or the first predetermined value, the term generation means 73 may set kᵢ to a value corresponding to the inverted state of the state of spin corresponding to the identification information in the solution, when the degree of wish to change paired with given identification information i of spin is a value between Vₐᵥₑ and the second predetermined value, or the second predetermined value, the term generation means 73 may set kᵢ to a value corresponding to the state of spin corresponding to the identification information in the solution, and the term generation means 73 may set a to a larger value the larger absolute value of a difference between the degree of wish to change and Vₐᵥₑ, and sets a to a smaller value the smaller absolute value of the difference between the degree of wish to change and Vₐᵥₑ.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The invention is suitably applied to the derivation of an energy function in the case of resolving combinatorial optimization problems.

### REFERENCE SIGNS LIST

1 Energy function derivation device

2 Input unit

3 Term generation unit

4 Energy function derivation unit

What is claimed is:

1. A energy function derivation device comprising:
a memory configured to store instructions; and
a processor configured to execute the instructions to:
generate a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and
derive a new energy function by adding terms generated by the processor for each pair to the energy function.

2. The energy function derivation device according to claim 1,
wherein
when given identification information is denoted as i, a value corresponding to the state of spin corresponding to the identification information in the solution or an inverted state of the state is denoted as k., a variable representing the state of spin corresponding to the identification information is denoted as xᵢ, and a value according to the degree of wish to change paired with the identification information is denoted as α,
the processor generates the term of form α×(kᵢ−xᵢ)² for each pair of the identification information and the degree of wish to change.

3. The energy function derivation device according to claim 2,
wherein the degree of wish to change is a continuous value ranging from a first predetermined value which means that the state of spin corresponding to the identification information paired with the degree of wish to change will be changed without fail, to a second predetermined value which means that the state of spin corresponding to the identification information paired with the degree of wish to change will never be changed,
an average of the first predetermined value and the second predetermined value is denoted as Vₐᵥₑ,
when the degree of wish to change paired with given identification information i of spin is a value between Vₐᵥₑ and the first predetermined value, or the first predetermined value, the processor sets kᵢ to a value corresponding to the inverted state of the state of spin corresponding to the identification information in the solution,
when the degree of wish to change paired with given identification information i of spin is a value between Vₐᵥₑ and the second predetermined value, or the second predetermined value, the processor sets kᵢ to a value corresponding to the state of spin corresponding to the identification information in the solution, and
the processor sets a to a larger value the larger absolute value of a difference between the degree of wish to change and Vₐᵥₑ, and sets a to a smaller value the smaller absolute value of the difference between the degree of wish to change and Vₐᵥₑ.

4. A energy function derivation method comprising:
generating a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and deriving a new energy function by adding terms generated for each pair to the energy function.

5. The energy function derivation method according to claim 4, further comprising:
when given identification information is denoted as i, a value corresponding to the state of spin corresponding to the identification information in the solution or an inverted state of the state is denoted as kᵢ, a variable representing the state of spin corresponding to the identification information is denoted as xᵢ, and a value according to the degree of wish to change paired with the identification information is denoted as α,
generating the term of form α×(kᵢ−xᵢ)² for each pair of the identification information and the degree of wish to change.

6. The energy function derivation method according to claim 5,
wherein the degree of wish to change is a continuous value ranging from a first predetermined value which means that the state of spin corresponding to the identification information paired with the degree of wish to change will be changed without fail, to a second predetermined value which means that the state of spin corresponding to the identification information paired with the degree of wish to change will never be changed,
an average of the first predetermined value and the second predetermined value is denoted as Vₐᵥₑ,
wherein the energy function derivation method comprises:
when the degree of wish to change paired with given identification information i of spin is a value between Vₐᵥₑ and the first predetermined value, or the first predetermined value, setting kᵢ to a value corresponding to the inverted state of the state of spin corresponding to the identification information in the solution,
when the degree of wish to change paired with given identification information i of spin is a value between Vₐᵥₑ and the second predetermined value, or the second predetermined value, setting kᵢ to a value corresponding to the state of spin corresponding to the identification information in the solution, and
setting α to a larger value the larger absolute value of a difference between the degree of wish to change and Vₐᵥₑ, and setting α to a smaller value the smaller absolute value of the difference between the degree of wish to change and Vₐᵥₑ.

7. A non-transitory computer-readable recording medium in which an energy function derivation program is recorded, wherein the energy function derivation program causes a computer to execute:
a term generation process of generating a term, when a solution to a combinatorial optimization problem, an energy function, which is used to obtain the solution, of a model representing states of individual spins by a first value or a second value, and a pair of identification information of spin and degree of wish to change which indicates degree to which an user wishes to change state of spin corresponding to the identification information in the solution are given, wherein the term is generated for each pair of the identification information and the degree of wish to change, based on the state of spin corresponding to the identification information in the solution and the degree of wish to change, and
an energy function derivation process of deriving a new energy function by adding terms generated in the term generation process for each pair to the energy function.

8. The non-transitory computer-readable recording medium in which the energy function derivation program is recorded, according to claim 7,
wherein the energy function derivation program causes the computer to execute, in the term generation process:
when given identification information is denoted as i, a value corresponding to the state of spin corresponding to the identification information in the solution or an inverted state of the state is denoted as kᵢ, a variable representing the state of spin corresponding to the identification information is denoted as xᵢ, and a value according to the degree of wish to change paired with the identification information is denoted as α,
generating the term of form α×(kᵢ−xᵢ)² for each pair of the identification information and the degree of wish to change.

9. The non-transitory computer-readable recording medium in which the energy function derivation program is recorded, according to claim 8,
wherein the degree of wish to change is a continuous value ranging from a first predetermined value which means that the state of spin corresponding to the identification information paired with the degree of wish to change will be changed without fail, to a second predetermined value which means that the state of spin corresponding to the identification information paired with the degree of wish to change will never be changed,
an average of the first predetermined value and the second predetermined value is denoted as Vₐᵥₑ,
wherein the energy function derivation program causes the computer to execute, in the term generation process:
when the degree of wish to change paired with given identification information i of spin is a value between Vₐᵥₑ and the first predetermined value, or the first predetermined value, setting kᵢ to a value corresponding to the inverted state of the state of spin corresponding to the identification information in the solution,
when the degree of wish to change paired with given identification information i of spin is a value between Vₐᵥₑ and the second predetermined value, or the second predetermined value, setting kᵢ to a value corresponding to the state of spin corresponding to the identification information in the solution, and
setting α to a larger value the larger absolute value of a difference between the degree of wish to change and Vₐᵥₑ, and setting α to a smaller value the smaller absolute value of the difference between the degree of wish to change and Vₐᵥₑ.
